(19) United States
(12) Patent Application Publication
(10) Pub. No.: US 2010/0063936 A1
(43) Pub. Date: Mar. 11, 2010

(54) METHOD AND SYSTEM FOR EVALUATING RISK MITIGATION PLAN ALTERNATIVES

(76) Inventors: N Dayasindhu, Bangalore (IN); Venkatakrishnan Balasubramanian, Tamilnadu (IN); Ankur Chhabra, Haryana (IN)

Correspondence Address: MICHAEL BEST & FRIEDRICH LLP, 100 E WISCONSIN AVENUE, Suite 3300, MILWAUKEE, WI, 53202, US

(21) Appl. No.: 12/536,834

(22) Filed: Aug. 6, 2009

(30) Foreign Application Priority Data
Aug. 6, 2008 (IN) 1889/CHE/2008

(51) Int. Cl. G06Q 10/00; G06N 5/02

(52) U.S. Cl. 705/348; 706/52

(57) ABSTRACT

The present invention provides a method, system and computer program product for evaluating risk mitigation plan alternatives, to manage the risks related to a business process. A criteria model is defined, including one or more criteria against which the risk mitigation plan alternatives are evaluated. Weights are also assigned to the criteria. One or more risk assessors assign scores to the risk mitigation plan alternatives with reference to the criteria model, based on a predefined scale. Thereafter, the utility values of the risk mitigation plan alternatives are calculated, based on the weight and a probability assigned by a risk assessor, wherein the probability is a measure of the uncertainty in the score assigned to the criteria. The risk mitigation plan alternatives are evaluated, based on the utility values, and accordingly, an optimal risk-mitigation plan may be selected.

### BACKGROUND

The present invention relates to risk mitigation in business processes. In particular, the invention relates to a method for evaluating risk mitigation plan alternatives for a business process and selecting an optimal risk-mitigation plan.

Managing risks related to a business process is a critical factor for its successful completion. For instance, projects in the Information Technology (IT) domain are linked with numerous aspects of the Software Development Life Cycle (SDLC), which in turn may increase the potential of risks. Proper scoping of requirements, design evaluation, technology selection and effort estimation are some of the potential risks. Management of such risks plays an important role in successful completion of IT projects.

Currently, many organizations have processes and systems for identification and management of risks. However, the focus of such processes and systems is mostly on identification of risks and documentation of risk-mitigation plans. There is minimal emphasis on evaluation of such risk mitigation plan alternatives and selection of an optimal risk-mitigation plan.

Some organizations operating in the IT domain have expert groups that specialize in deciding and analyzing key activities of an SDLC. Such activities include risk management, requirements engineering, software validation, and the like. These expert groups work on a project to review aspects related to their area of expertise. Often, expert groups involved in risk management work in isolation while identifying risks and suggesting risk mitigation plan alternatives. Therefore, identification of risks and risk mitigation plan alternatives is performed without the involvement of ‘key stakeholders’ in the project, such as business experts, technical experts and the engineering team. Such processes in organizations do not take into account each stakeholder's view on various risk mitigation plan alternatives and their corresponding impact on reducing risks.

In light of the above, there is a need for a method that involves key stakeholders of every project in the identification of potential risks and risk mitigation plan alternatives for the project. There is also a need for a structured evaluation of various risk mitigation plan alternatives and selection of an optimal risk-mitigation plan.

### SUMMARY

An object of the invention is to evaluate risk mitigation plan alternatives for selecting an optimal risk-mitigation plan for a business process.

Another object of the invention is to involve key stakeholders of the business process in the identification of risks and evaluation of risk mitigation plan alternatives.

To achieve the objectives mentioned above, the invention provides a method, system and computer program product for evaluating risk mitigation plan alternatives to manage risks related to business processes. A plurality of risk mitigation plan alternatives to be evaluated is defined by experts. The experts then specify the details pertaining to the description and execution of each of these risk mitigation plan alternatives. A criteria model including one or more criteria is defined against which the risk mitigation plan alternatives need to be evaluated. Weights are assigned to the criteria depending on the relative impact of the criteria on reducing risks. Further, key stakeholders of the business process assign scores to the risk mitigation plan alternatives with reference to the criteria model, based on a predefined scale. In an embodiment of the invention, probabilities are also assigned to the scores, depending on the uncertainty in the assigned score. The uncertainty in the assigned score is captured as probability by using the “standard gambling” technique, as suggested by Keeney R L, Raiffa H. “Decisions with multiple objectives: preferences and value tradeoffs”, Cambridge University Press, 1993. Thereafter, utility values are calculated for the risk mitigation plan alternatives on the basis of the probabilities assigned to the criteria. Utility is a measure of desirability or satisfaction and provides a uniform scale to compare and/or combine tangible and intangible criteria, as described by A. H. S. Ang & W. H. Tang, 1984, “Probability concepts in engineering planning and design”, Volume II Decision, Risk & Reliability, John Wiley, NY. The calculated utility values help in evaluation of the risk mitigation plan alternatives.

### BRIEF DESCRIPTION OF THE DRAWINGS

The various embodiments of the invention will hereinafter be described in conjunction with the appended drawings, provided to illustrate, and not to limit, the invention, wherein like designations denote like elements, and in which:

FIG. 1 illustrates an environment in which various embodiments of the invention may be practiced, in accordance with an embodiment of the invention;

FIG. 2 is a flowchart illustrating a method for evaluating risk mitigation plan alternatives and selecting an optimal risk-mitigation plan, in accordance with an embodiment of the invention;

FIG. 3 is a block diagram of a system for evaluating one or more risk mitigation plan alternatives, in accordance with an embodiment of the invention;

FIG. 4 is a block diagram of a risk-mitigation input module, in accordance with an embodiment of the invention;

FIG. 5 is a block diagram of a criteria-definition module, in accordance with an embodiment of the invention;

FIG. 6 is a block diagram of a weight-definition module, in accordance with an embodiment of the invention;

FIG. 7 is a block diagram of a scale-definition module, in accordance with an embodiment of the invention;

FIG. 8 is a block diagram of a risk-assessor module, in accordance with an embodiment of the invention;

FIG. 9 is a block diagram of a scoring module, in accordance with an embodiment of the invention;

FIG. 10 is a block diagram of a scoring module, in accordance with another embodiment of the invention;

FIG. 11 is a block diagram of a probability assignment module, in accordance with an embodiment of the invention;

FIG. 12 is a block diagram of a report-generation module, in accordance with an embodiment of the invention;

FIG. 13 is a screenshot of a user interface of a system for evaluating one or more risk mitigation plan alternatives, in accordance with an exemplary embodiment of the invention;

FIG. 14 is a screenshot of the user interface of the system for evaluating one or more risk mitigation plan alternatives, in accordance with an exemplary embodiment of the invention;

FIG. 15 is a screenshot of a user interface of a system for evaluating one or more risk mitigation plan alternatives, in accordance with another exemplary embodiment of the invention; and

FIG. 16 is a screenshot of the user interface of the system for evaluating one or more risk mitigation plan alternatives, in accordance with another exemplary embodiment of the invention.

### DESCRIPTION OF VARIOUS EMBODIMENTS

The invention describes a method, system and computer program product for evaluating risk mitigation plan alternatives to manage risks related to a business process. The method includes defining one or more risk mitigation plan alternatives related to the business process. Further, a criteria model including one or more criteria is defined, and based on the criteria model, risk mitigation plan alternatives are evaluated. The risk mitigation plan alternatives are evaluated against the criteria model. Each criterion is assigned a ‘weight’, depending on the relative impact of the criterion on reducing the risks related to the business process. Furthermore, one or more experts assign scores to the plurality of risk mitigation plan alternatives with reference to the criteria model. Thereafter, the risk mitigation plan alternatives are evaluated, based on the assigned scores, and based on the evaluation, an optimal risk-mitigation plan is selected.

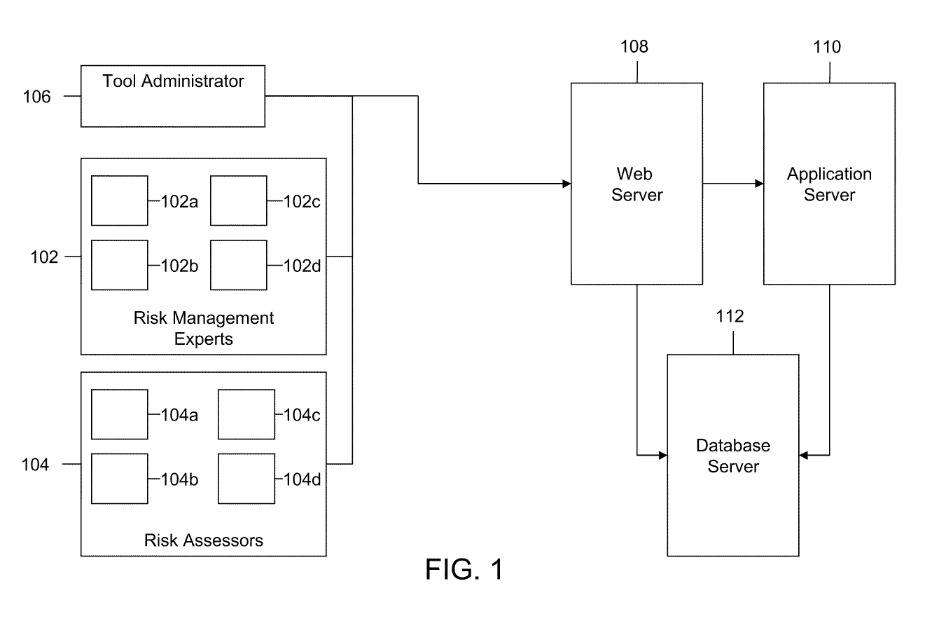

FIG. 1 illustrates an environment 100 in which various embodiments of the invention may be practiced. Environment 100 includes one or more risk management experts, such as risk management experts 102a, 102b, 102c and 102d, hereinafter referred to as risk management experts 102, one or more risk assessors, such as one or more risk assessors 104a, 104b, 104c and 104d, hereinafter referred to as risk assessors 104, a tool administrator 106, a web server 108, an application server 110, and a database server 112.

Risk management experts 102 define risk mitigation plan alternatives to manage risks related to a business process. Risk management experts 102 also define a criteria model against which the risk mitigation plan alternatives are evaluated. Based on the definitions provided by risk management experts 102, risk assessors 104 evaluate risk mitigation plan alternatives by assigning scores to the risk mitigation plan alternatives. Tool administrator 106 has the capability of assigning different roles and corresponding access rights to risk management experts 102 and risk assessors 104.

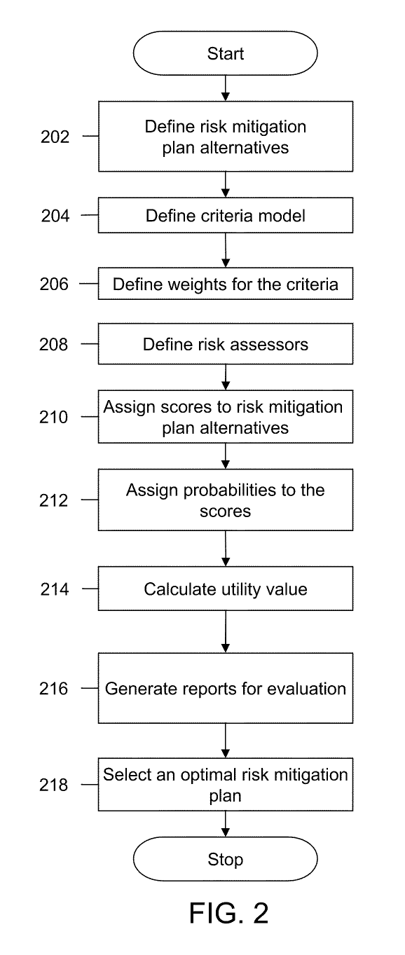

Web server 108 enables risk management experts 102 and risk assessors 104 to access and update the information related to the risk mitigation plan alternatives. Application server 110 contains the business logic related to the flow of execution of the system for evaluation of risk mitigation plan alternatives. Database server 112 includes database entities to support storage of information related to the evaluation of risk mitigation plan alternatives. The method for evaluating risk mitigation plan alternatives is described in conjunction with FIG. 2.

FIG. 2 is a flowchart illustrating a method for evaluating risk mitigation plan alternatives and selecting an optimal risk-mitigation plan, in accordance with an embodiment of the invention. At 202, risk mitigation plan alternatives that need to be evaluated in relation to the business process are defined. At 204, a criteria model including one more criteria is defined. In an embodiment of the invention, the criteria model may be a hierarchical model including one or more sub-criteria that are defined under the criteria. For example, a criterion, corresponding to a risk of attrition in a business establishment, may include compensatory benefits, promotion policies, employee friendliness and work culture. Further, the sub-criteria for the criterion ‘employee friendliness’ may include recreational facilities and flexible working hours.

At 206, weights are defined for each criterion. The weights are defined on the basis of the relative impact of the criteria on reducing the risks related to the business process. Thereafter at 208, one or more risk assessors are defined for evaluating the risk mitigation plan alternatives.

After the criteria model, the risk mitigation plan alternatives and the risk assessors have been defined, the risk mitigation plan alternatives are evaluated by the risk assessors with reference to the criteria. Accordingly, at 210, scores are assigned to the risk mitigation plan alternatives with reference to the criteria and on the basis of a predefined scale. In an embodiment of the invention, the predefined scale may be customized for a business process. In various embodiments of the invention, the scores are assigned by one or more risk assessors. For example, for a business process related to the Information Technology (IT) domain, scores may be assigned by project managers, delivery managers or general managers. Thereafter, at 212, a probability is assigned to each score. The probability is a measure of uncertainty of the score assigned to the risk mitigation plan alternatives.

Subsequently, at 214, a utility value is calculated for the risk mitigation plan alternatives with reference to the criteria. The utility value is calculated by multiplying the weights defined for the criteria and the probabilities assigned to the scores of the criteria. In various embodiments of the invention, 210, 212 and 214 are repeated for every risk assessor. At 216, one or more reports including the utility values corresponding to each of the risk mitigation plan alternatives are generated. The reports facilitate selection of an optimal risk-mitigation plan at 218. In an exemplary embodiment of the invention, graphical reports may be generated, based on the evaluation, to facilitate comparison of risk mitigation plan alternatives and subsequent selection of an optimal risk-mitigation plan.

In an exemplary embodiment of the invention, documents containing planning and execution details of the risk mitigation plan alternatives may also be provided for reference.

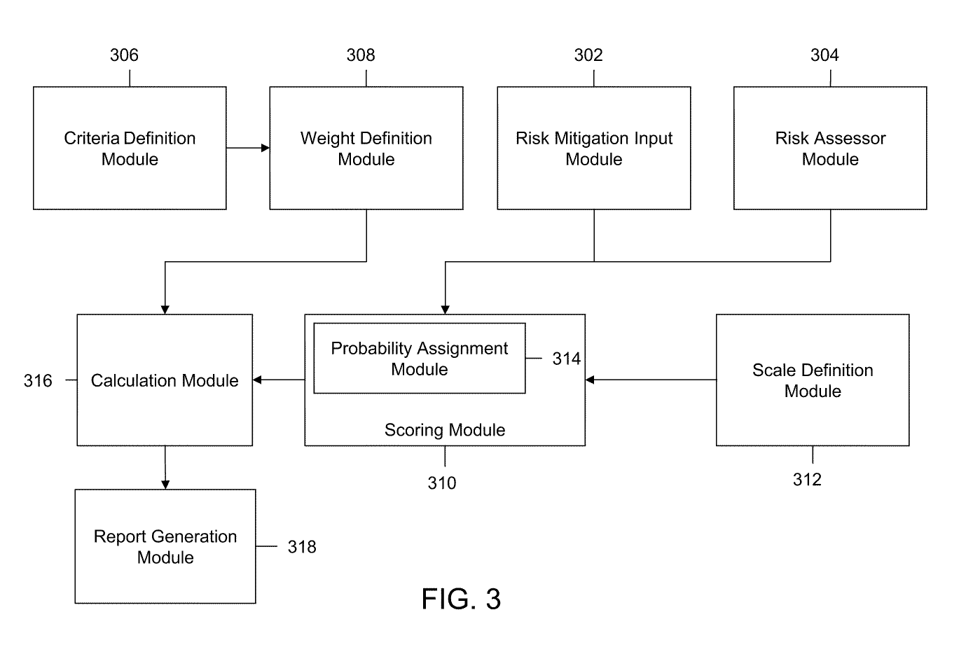

FIG. 3 is a block diagram of a system for evaluating one or more risk mitigation plan alternatives, in accordance with an embodiment of the invention. FIG. 3 includes a risk-mitigation input module 302, a risk-assessor module 304, a criteria-definition module 306, a weight-definition module 308, a scoring module 310, a scale-definition module 312, a calculation module 316 and a report-generation module 318. Scoring module 310 includes a probability assignment module 314.

Risk-mitigation input module 302 enables risk management experts 102 to define one or more risk mitigation plan alternatives that need to be evaluated for a business process. In an embodiment of the invention, risk-mitigation input module 302 enables risk management experts 102 to define planning and execution details of the risk mitigation plan alternatives. In various embodiments of the invention, risk management experts 102 may include, but are not limited to, a general manager, professionals from the corporate group, the quality group and other professionals from the senior management of a business establishment. Similarly, risk management experts 102 assign risk assessors 104 for evaluating the risk management plan alternatives through risk assessor module 304. In various embodiments of the invention, risk assessors 104 may include, but are not limited to, a project manager, a delivery manager related to the business process and a general manager of the business establishment. In another embodiment of the invention, risk assessors 104 and risk management experts 102 may be the same.

Once risk management experts 102 and risk assessors 104 have been assigned, criteria definition module 306 enables risk management experts 102 to define a criteria model including one or more criteria. The risk management plan alternatives are evaluated against the criteria model. In an embodiment of the invention, the criteria model may be a hierarchical model including a plurality of sub-criteria corresponding to each of the one or more criteria.

Weight-definition module 308 enables risk management experts 102 to define weights for the one or more criteria, based on the relative impact of the criteria on reducing the risks. In various embodiments of the invention, the sum of the weights defined for all criteria is equal to one. Similarly, in various embodiments of the invention, the sum of the weights defined for all sub-criteria defined under each criterion is also equal to one.

Scoring module 310 enables risk assessors 104 to assign scores to the risk mitigation plan alternatives with reference to each of the criteria and sub-criteria, to evaluate the risk mitigation plan alternatives.

Scores are assigned, based on a predefined scale. Scale-definition module 312 enables risk management experts 102 to customize the definition of the predefined scale according to the risks being managed. In an embodiment of the invention, scale-definition module 312 may enable risk management experts 102 to customize the scale for assigning scores to the risk mitigation plan alternatives.

Scoring module 310 includes probability assignment module 314 for enabling risk assessors 104 to assign a probability to each assigned score. The probability is a measure of uncertainty of the score assigned to the risk mitigation plan alternatives. For example, in an embodiment of the invention, the lowest score may be assigned a probability of 0 and the highest score may be assigned a probability of 1. The other scores may be assigned probabilities between 0 and 1, depending on the degree of uncertainty of the scores.

A business establishment may want to come up with a program to reduce employee attrition that has been identified as an important risk factor. The criteria that influences employee attrition may include compensatory benefits, promotion policies, employee friendliness and work culture. The business establishment can propose a plurality of programs, also referred to as the plurality of risk mitigation plan alternatives, to reduce employee attrition. Each of these programs may have a different impact on the criteria listed above. For example, the plurality of programs may be referred to as Program 1, Program 2, Program 3 and Program 4, wherein Program 1 has a low impact on the criteria ‘compensatory benefits’, Program 2 has a moderate impact on compensatory benefits while Programs 3 and 4 have a high impact on compensatory benefits, with Program 4 having the highest impact.

The scale for assigning scores to the criteria may be as follows:

| | |
|---|---|
| Low Impact | 0-5 |
| Medium Impact | 5-10 |
| High Impact | 10-15 |

The scores assigned to the criteria by a risk assessor may be as follows:

| | Program 1 | Program 2 | Program 3 | Program 4 |
|---|---|---|---|---|
| Compensatory | 7 | 10 | 12 | 15 |
| Benefits | | | | |

The probability assigned to the lowest score ‘7’ is 0, and the probability assigned to the highest score ‘15’ is 1. The probabilities for the intermediate scores are calculated, based on the “standard gambling” technique. Considering the case of Program 2, the risk assessor has the following two options:

Certain option: The risk assessor is certain that the impact of Program 2 on compensatory benefits is 10.
Risk option: The risk assessor is toying with the probable outcome (p) of receiving maximum impact, which is 15, of a program on compensatory benefits, and the probable outcome (1-p) of minimum impact that is 7.

If the risk assessor assigns the value of ‘p’ as 0.3 to Program 2, it means that the risk assessor is not considering the certain option and the risk option. Similarly, using the “standard gaming” technique, a probability of 0.8 is assigned to Program 3.

| | Program 1 | Program 2 | Program 3 | Program 4 |
|---|---|---|---|---|
| Compensatory | 0 | 0.3 | 0.8 | 1 |
| Benefits | | | | |

Calculation module 316 then calculates a utility value of each risk mitigation plan alternative with reference to each criterion. Calculation module 316 takes the probability assigned to each score from scoring module 310 and the weights defined for the criterion from weight-definition module 308 as input, to calculate the utility value. The utility value is calculated by multiplying the probability assigned to the scores of the criteria with the respective weight of the criteria. An overall utility value of the risk mitigation plan alternatives is calculated by adding the utility values determined for the criteria. The risk mitigation plan alternatives are evaluated, based on the calculated utility values.

Report-generation module 318 then generates reports containing utility values of the risk mitigation plan alternatives with reference to the criteria. The generated reports facilitate evaluation of the risk mitigation plan alternatives. An optimal risk-mitigation plan is selected according to the evaluation.

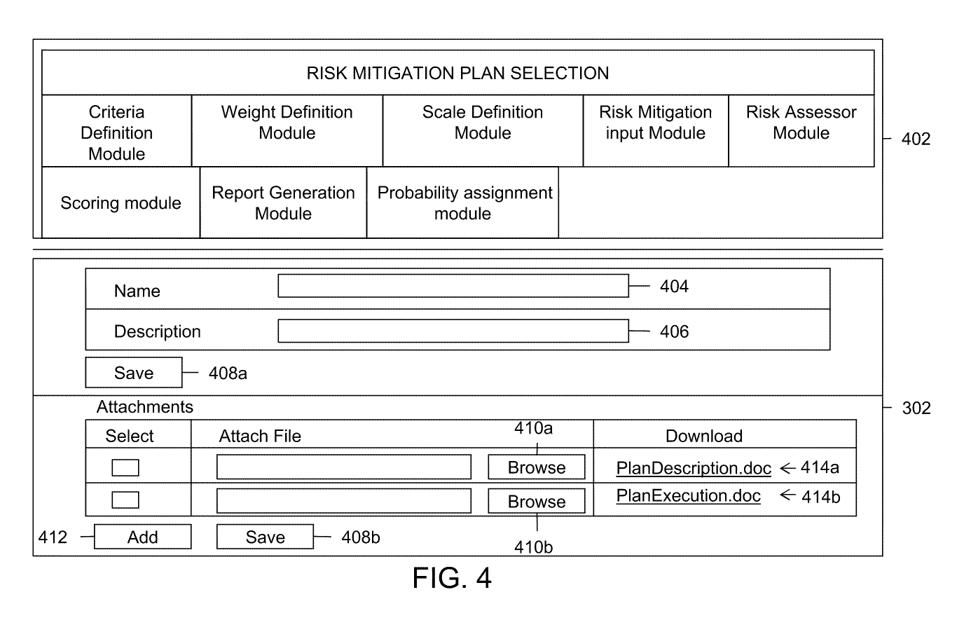

FIG. 4 is a block diagram of risk-mitigation input module 302, in accordance with an exemplary embodiment of the invention. FIG. 4 includes a menu bar 402, a plurality of textboxes 404 and 406, and a plurality of buttons, such as a save button 408, one or more browse buttons 410a and 410b, hereinafter referred to as browse button 410, an add button 412, and one or more hyperlinked documents 414a and 414b. Menu bar 402 includes risk-mitigation input module 302, risk-assessor module 304, criteria-definition module 306, weight-definition module 308, scoring module 310, scale-definition module 312, probability assignment module 314 and report-generation module 318.

Risk-mitigation input module 302 enables risk management experts 102 to define one or more risk mitigation plan alternatives that need to be evaluated. A name of a risk-mitigation plan and a corresponding description are entered in textboxes 404 and 406, respectively. The name and description entered are saved by clicking on button 408a. Risk management experts 102 may also upload documents related to the description and execution of the risk management plan alternatives for subsequent reference. The documents are uploaded from a computer by using browse button 410, and subsequently stored in a database such as database server 112. Additional documents may be uploaded and saved by clicking on add button 412 and save button 408b, respectively. Further, an uploaded file may be downloaded from the database by clicking on hyperlinked documents 414a and 414b. After the risk mitigation plan alternatives have been defined, risk management experts 102 defines a criteria model and weights for each criterion.

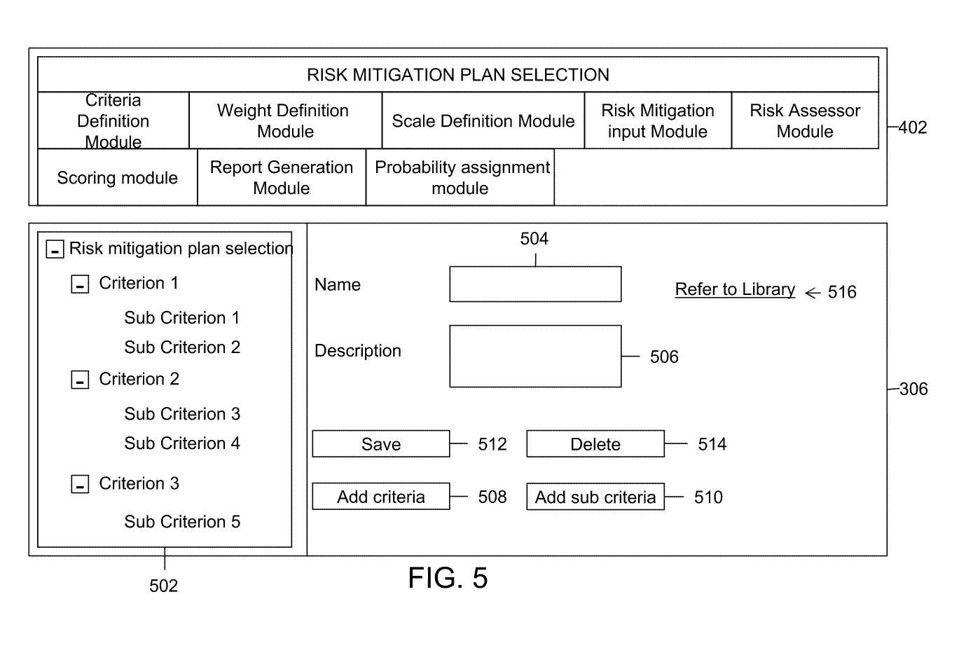

FIG. 5 is a block diagram of criteria-definition module 306, in accordance with an embodiment of the invention. FIG. 5 includes menu bar 402 and criteria-definition module 306. Criteria-definition module 306 includes a criteria model tree 502, a plurality of textboxes 504 and 506, and a plurality of buttons, such as an add criteria button 508, an add sub-criteria button 510, a save button 512, a delete button 514 and a refer-to-library link 516.

Criteria-definition module 306 enables risk management experts 102 to define the criteria against which the risk mitigation plan alternatives are evaluated. Criteria model tree 502 depicts a hierarchical structure of one or more criteria, including one or more sub-criteria defined for the one or more criteria.

Textboxes 504 and 506 enable risk management experts 102 to provide a name and a description for a new criterion to be added. On clicking a criterion in criteria model tree 502, a new criterion can be added to the corresponding position by clicking on add criteria button 508. Similarly, a sub-criterion may also be added by clicking on add sub-criteria button 510. The defined criterion may be saved by clicking on save button 512. The criterion may also be deleted by clicking on delete button 514.

Refer-to-library link 516 provides a reference to a predefined library of criteria including one or more criteria models, such as criteria model tree 502, which can be used directly or can also be customized. The library of criteria may be stored in a database such as database server 112.

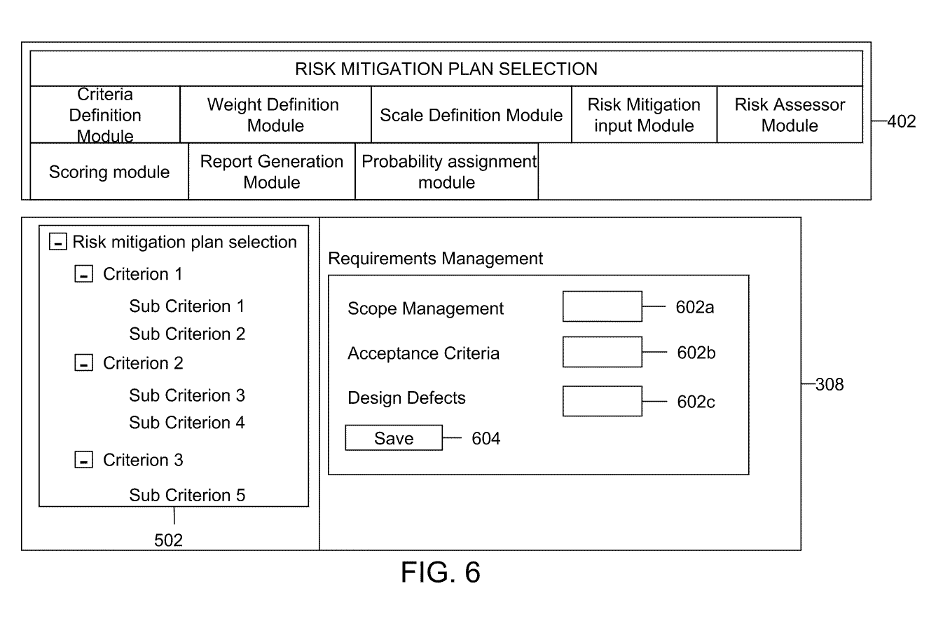

The criteria are then assigned weights, depending on the relative impact of the criteria on reducing risks. This is described in conjunction with FIG. 6.

FIG. 6 is a block diagram of weight-definition module 308, in accordance with an embodiment of the invention. FIG. 6 includes menu bar 402 and weight-definition module 308. Weight-definition module 308 includes criteria model tree 502, a plurality of textboxes 602a, 602b and 602c, and a save button 604.

Weight-definition module 308 enables risk management experts 102 to assign weights to the criteria. On clicking a criterion in criteria model tree 502, risk management experts 102 may assign weights to the sub-criteria, such as scope management, acceptance criteria, design defects, and the like. The weights may be assigned to the sub-criteria by inputting the weights in textboxes 602a, 602b and 602c. The assigned weights are saved by clicking on save button 604. In various embodiments of the invention, the summation of the weights assigned to all criteria is 1. Similarly, the summation of the weights assigned to all sub-criteria under each criterion is 1.

Risk management experts 102 then define the scale to evaluate the risk mitigation plan alternatives.

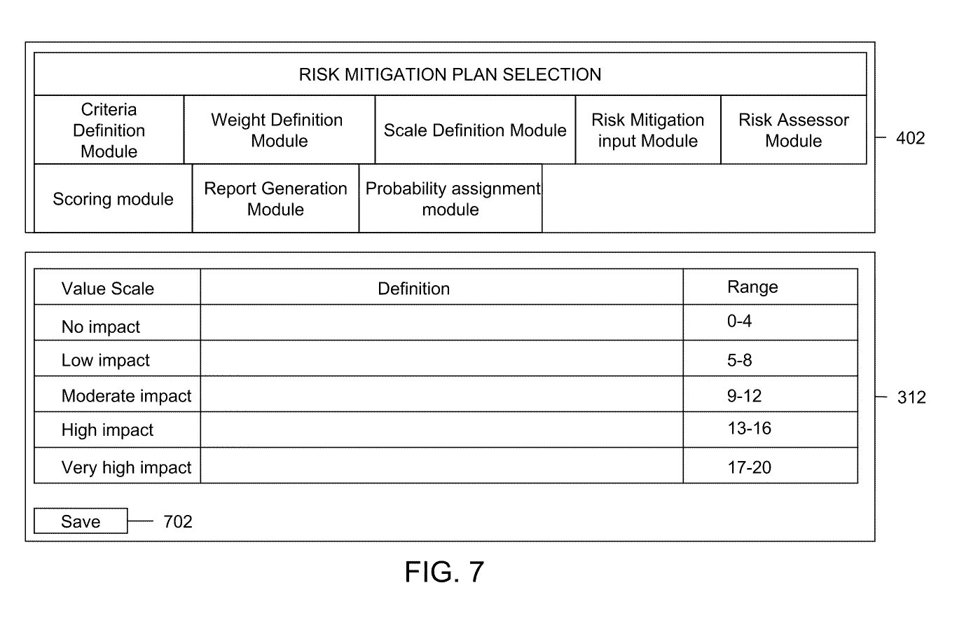

FIG. 7 is a block diagram of scale-definition module 312, in accordance with an embodiment of the invention. FIG. 7 includes menu bar 402 and scale-definition module 312.

Scale-definition module 312 enables risk management experts 102 to customize definitions for the predefined scale. As shown in FIG. 7, the value scale can have a plurality of categories, such as ‘No Impact’, ‘Low Impact’, ‘Moderate Impact’, ‘High Impact’ and ‘Very High Impact’. Such categories can then have their corresponding definitions to define the level of impact, or examples of the kind of impact for each category. Further, each of the plurality of categories in the value scale will have their corresponding range of values. In another embodiment of the invention, the value scale and its respective ranges can be customized. The defined scale may be saved in a database by clicking on a save button 702.

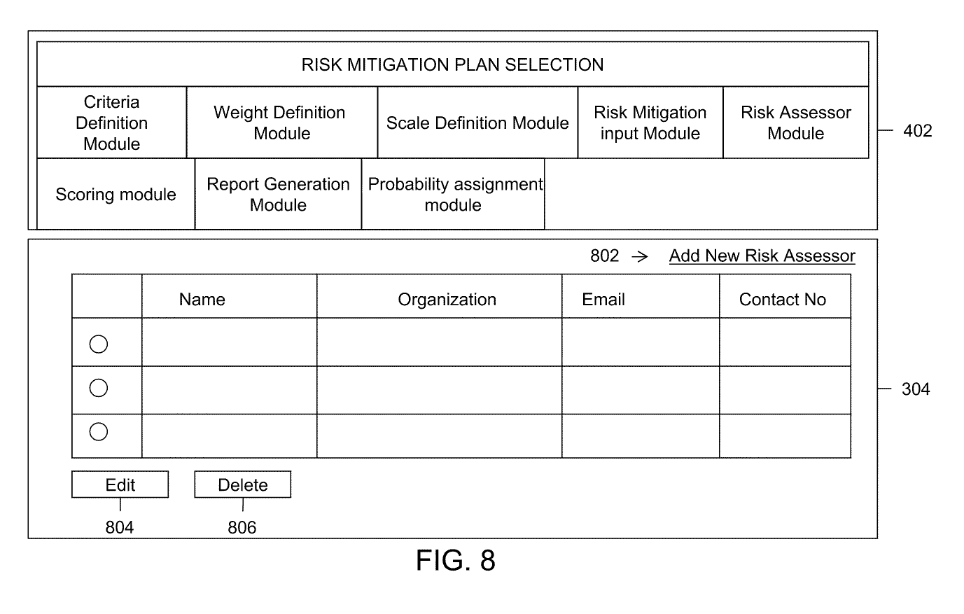

Risk management experts 102 define risk assessors 104 to evaluate the risk mitigation plan alternatives. This is described in conjunction with FIG. 8.

FIG. 8 is a block diagram of risk-assessor module 304, in accordance with an embodiment of the invention. FIG. 8 includes menu bar 402 and risk-assessor module 304. Risk-assessor module 304 includes an add-new-risk-assessor link 802, an edit button 804 and a delete button 806.

Risk-assessor module 304 enables risk management experts 102 to assign risk assessors 104 for evaluating the risk mitigation plan alternatives. Risk assessors 104 may be added by clicking on add-new-risk-assessor link 802. The contact details of the assigned risk assessors 104 may also be added by using edit button 804 or add-new-risk-assessor link 802. Further, details of the assigned risk assessors 104 may be edited by using edit button 804, and deleted by using delete button 806.

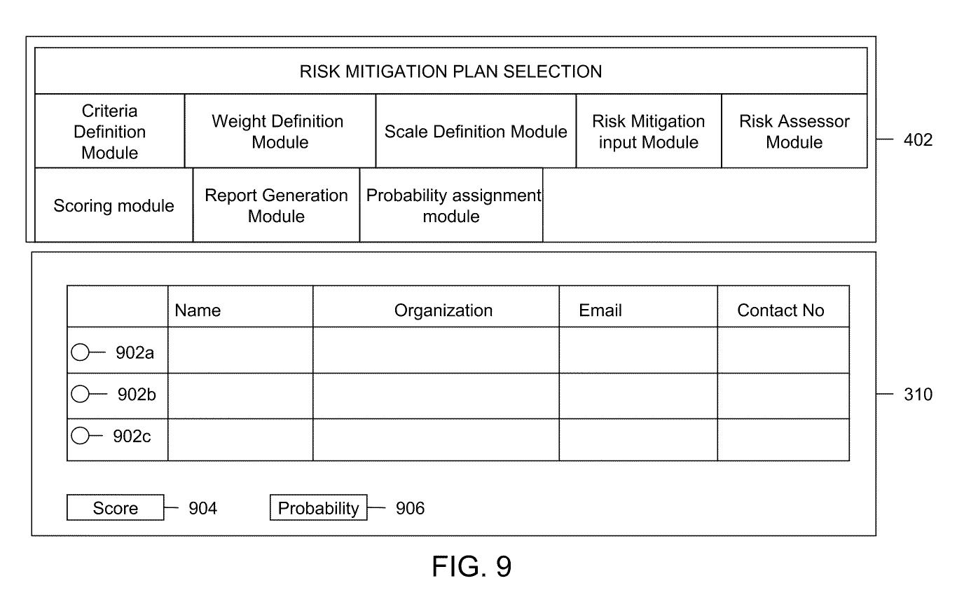

Risk assessors 104 then assign scores to the risk mitigation plan alternatives, based on the defined scale. This is described in conjunction with FIG. 9.

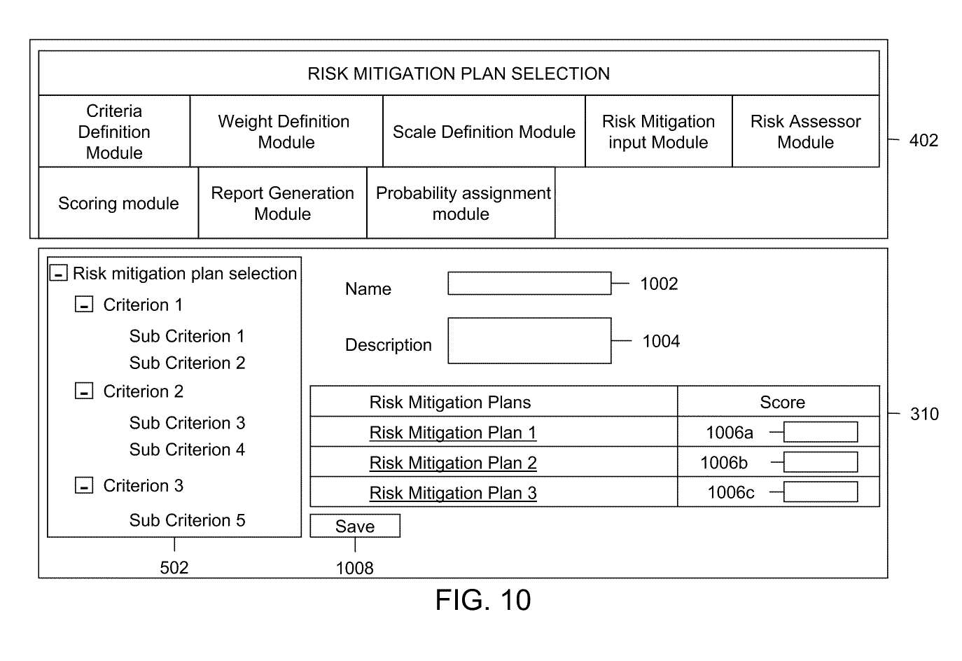

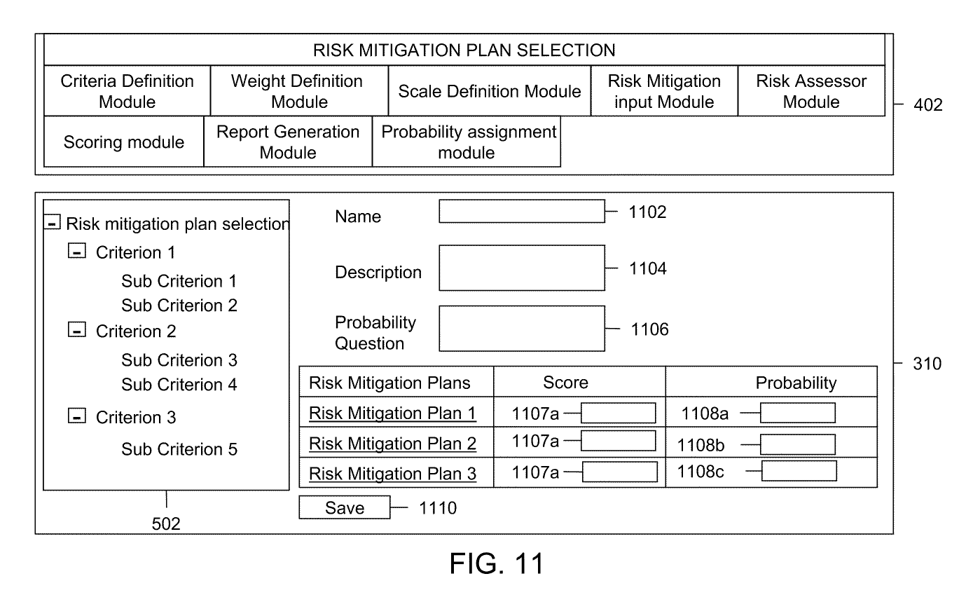

FIG. 9 is a block diagram of scoring module 310, in accordance with an embodiment of the invention. FIG. 9 includes menu bar 402 and scoring module 310. Scoring module 310 includes a plurality of buttons, such as one or more radio buttons 902a, 902b and 902c, hereinafter referred to as radio button 902, a score button 904 and a probability button 906. The risk management expert facilitates the risk assessors in evaluating the risk mitigation plan alternatives. The expert selects a risk assessor by clicking on radio button 902. The expert enables a risk assessor to assign scores to the risk mitigation plan alternatives by clicking on score button 904. Probabilities may be assigned to the assigned scores by clicking on probability button 906. Assignment of scores and probabilities is described in conjunction with FIG. 10 and FIG. 11.

FIG. 10 is a block diagram of scoring module 310, in accordance with another embodiment of the invention. FIG. 10 includes menu bar 402 and scoring module 310. Scoring module 310 includes criteria model tree 502, a plurality of textboxes 1002 and 1004, a score button 1006 and a save button 1008.

When a risk assessor, such as risk assessor 104a, clicks on a criterion in criteria model tree 502, the name and description corresponding to the selected criterion is reflected in textboxes 1002 and 1004, respectively. Risk assessor 104a then assigns scores to the risk mitigation plan alternatives with reference to the criterion selected. Since criteria model tree 502 is a hierarchical structure of criteria including one or more sub-criteria defined for each criterion, scores are only assigned to the sub-criteria.

The scores for the risk mitigation plan alternatives are entered in score buttons 1006a, 1006b and 1006c. The assigned scores are saved by clicking on save button 1008. Accordingly, scores may be assigned to the risk mitigation plan alternatives with reference to each sub-criterion by clicking on the sub-criterion in criteria model tree 502. Further, risk assessors 104 assign a probability to each score. This is described in conjunction with FIG. 11.

FIG. 11 is a block diagram of probability assignment module 314, in accordance with an embodiment of the invention. FIG. 11 includes menu bar 402 and probability assignment module 314. Probability assignment module 314 includes criteria model tree 502, a plurality of textboxes 1102, 1104 and 1106, a plurality of probability textboxes 1107a, 1107b and 1107c, a plurality of probability textboxes 1108a, 1108b and 1108c and a save button 1110.

When risk assessor 104a clicks on a criterion in criteria model tree 502, the name and description corresponding to the selected criterion is reflected in textboxes 1102 and 1104, respectively. Similarly, the plurality of probability textboxes 1107a, 1107b and 1107c displays the corresponding scores for each of the risk mitigation plan alternatives. Risk assessor 104a then assigns probability to each of the risk mitigation plan alternatives with reference to the selected criterion. The assigned probabilities are entered in probability textboxes 1108a, 1108b and 1108c. The assigned probabilities are a measure of the uncertainty of the score assigned to the risk mitigation plan alternatives with reference to the selected criterion. A probability question is generated to guide the risk assessor in assigning the probabilities. The probability question is reflected in textbox 1106 whenever the risk assessor wants to enter the probability in any of the text boxes 1108a or 1108b or 1108c. The assigned probabilities are then saved by clicking on save button 1110. Similarly, risk assessor 104a assigns probabilities to each sub-criterion in criteria model tree 502.

After the scores and probabilities have been assigned to the risk mitigation plan alternatives with reference to each criterion, a calculation module (not shown) calculates a utility value of the risk mitigation plan alternatives with reference to the criteria in criteria model tree 502. The utility value is calculated by multiplying the probabilities assigned to the criteria with their respective overall weights. The overall weight of every sub-criterion is calculated by multiplying the weight defined for the sub-criterion with the weight of the criterion that is above the sub-criterion in the hierarchical model, and so forth until the topmost criterion is reached. For example, with reference to criteria tree model 502, the weight of sub-criterion 1 is defined as Wsub1, and the weight of criterion 1 is defined as W1. The overall weight of sub-criterion 1 (W) to calculate the utility value is then determined as:

W≡Wsub1×W1 (1)

The overall utility value of a risk mitigation plan alternative is the summation of the utility values calculated for the criteria. In an embodiment of the invention, the calculation module may be implemented at the backend.

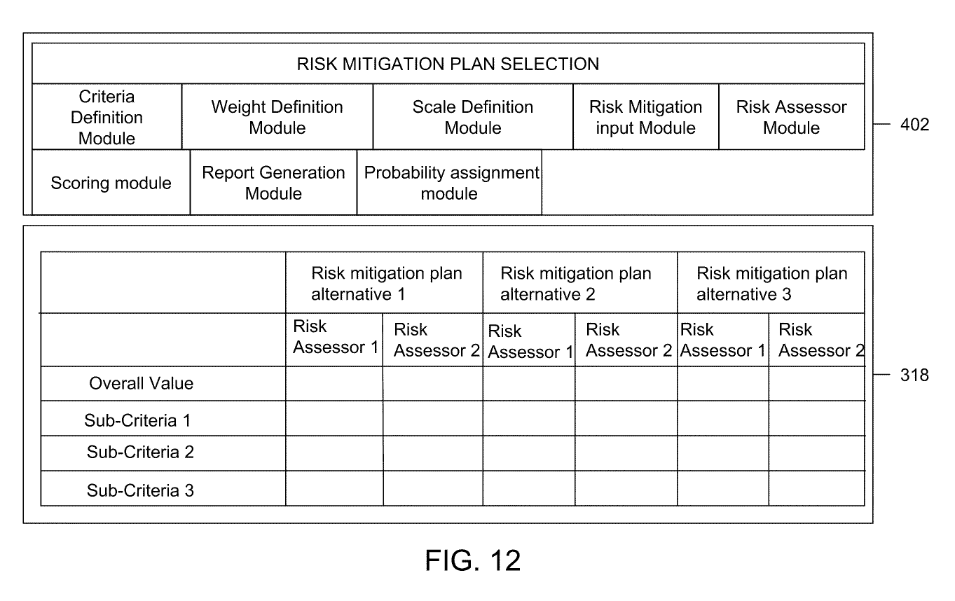

FIG. 12 is a block diagram of report-generation module 318, in accordance with an embodiment of the invention. FIG. 12 includes menu bar 402 and report-generation module 318.

Report-generation module 318 generates reports containing the calculated utility values of the risk mitigation plan alternatives with reference to the criteria. The overall utility values of the risk mitigation plan alternatives are also included. The generated reports facilitate evaluation of the risk mitigation plan alternatives and subsequent selection of an optimal risk-mitigation plan. In an embodiment of the invention, graphical reports may also be generated.

Considering the IT domain, a risk management expert may define a criteria model by using criteria-definition module 306, as follows:

| Criterion | Sub-criterion | Description |
|---|---|---|
| Requirement | Scope | To assess the degree to which the |
| Management | Management | choice of a risk-mitigation plan |
| | | influences accepting change requests |
| | | without the corresponding change in |
| | | schedule or revenue |
| | Design Defects | To assess the degree to which the |
| | | choice of a risk-mitigation plan |
| | | influences compliance to quality |
| | | standards |
| Project | Due Diligence in | To assess the degree to which the |
| Management | Estimation | choice of a risk-mitigation plan |
| | | influences due diligence in |
| | | estimation |
| | Compliance to | To assess the degree to which the |
| | CMMI Processes | choice of a risk-mitigation plan |
| | | influences planning for CMMI |
| | | Level 5 project execution |

The weights for the criteria may be defined using weight-definition module 308, as follows:

| Criterion | Criterion | Sub-criterion | Sub-criterion | Overall |
|---|---|---|---|---|
| Requirement | 0.6 | Scope Management | 0.7 | 0.42 |
| Management | | Design Defects | 0.3 | 0.18 |
| Project | 0.4 | Due Diligence in | 0.4 | 0.16 |
| Management | | Estimation | | |
| | | Compliance to CMMI | 0.6 | 0.24 |
| | | Processes | | |

The sum of the weights assigned to the criteria is equal to one. The sum of the weights assigned to all sub-criteria under each criterion is also equal to one. Further, the overall weight of each sub-criterion is calculated by multiplying the weight assigned to the sub-criterion with the weight assigned to the criterion under which the sub-criterion has been defined.

For three risk mitigation plan alternatives, a risk assessor may assign scores to the risk mitigation plan alternatives with reference to the criteria by using scoring module 310. The scores may be assigned according to a predefined scale, as follows:

| | Risk | Risk | Risk |
|---|---|---|---|
| | Mitigation Plan | Mitigation Plan | Mitigation Plan |
| Criterion | Alternative 1 | Alternative 2 | Alternative 3 |
| Scope | 10 | 12 | 16 |
| Management | | | |
| Design Defects | 12 | 10 | 15 |
| Due Diligence in | 8 | 12 | 6 |
| Estimation | | | |
| Compliance to | 14 | 18 | 9 |
| CMMI Processes | | | |

The probabilities may be assigned to the scores, as follows:

| | Risk | Risk | Risk |
|---|---|---|---|
| | Mitigation Plan | Mitigation Plan | Mitigation Plan |
| Criterion | Alternative 1 | Alternative 2 | Alternative 3 |
| Scope | 0 | 0.8 | 1 |
| Management | | | |
| Design Defects | 0.9 | 0 | 1 |
| Due Diligence in | 0.7 | 1 | 0 |
| Estimation | | | |
| Compliance to | 0.4 | 1 | 0 |
| CMMI Processes | | | |

The utility value is calculated by multiplying the probabilities assigned to the sub-criteria with the overall weight of the sub-criteria.

| | Risk | Risk | Risk |
|---|---|---|---|
| | Mitigation Plan | Mitigation Plan | Mitigation Plan |
| | Alternative 1 | Alternative 2 | Alternative 3 |
| Scope | 0 | 0.336 | 0.42 |
| Management | | | |
| Design Defects | 0.162 | 0 | 0.18 |
| Due Diligence in | 0.112 | 0.16 | 0 |
| Estimation | | | |
| Compliance to | 0.096 | 0.24 | 0 |
| CMMI Processes | | | |
| Overall Utility | 0.37 | 0.736 | 0.6 |
| Value | | | |

The overall utility values of the risk mitigation plan alternatives indicate that Risk Mitigation Plan Alternative 2 is the optimal risk-mitigation plan for the risk assessor.

Report-generation module 318 generates reports containing overall utility values facilitating comparison of risk mitigation plan alternatives and subsequent selection of an optimal risk-mitigation plan.

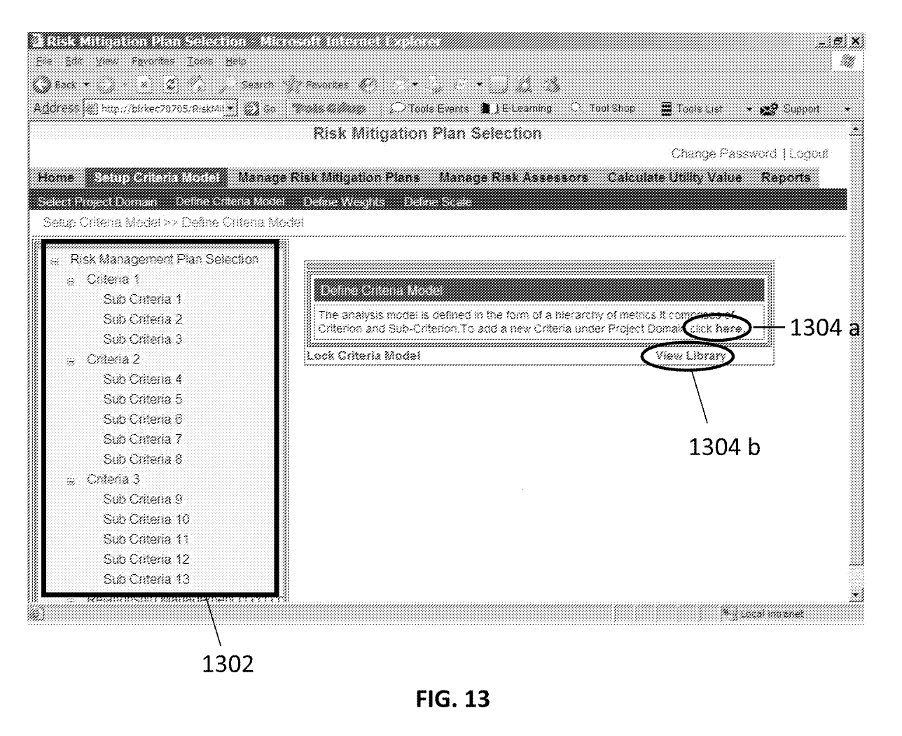

FIG. 13 is an exemplary screenshot of a user interface of a system for evaluating one or more risk mitigation plan alternatives, in accordance with an exemplary embodiment of the invention. The user interface includes a criteria model tree 1302 corresponding to criteria model tree 502. Criteria model tree 1302 is a hierarchical model including sub-criteria under each criterion.

A new criterion may be added to criteria model tree 1302 by clicking on a link 1304a. A predefined library of criteria stored in a database may be accessed by clicking on a link 1304b.

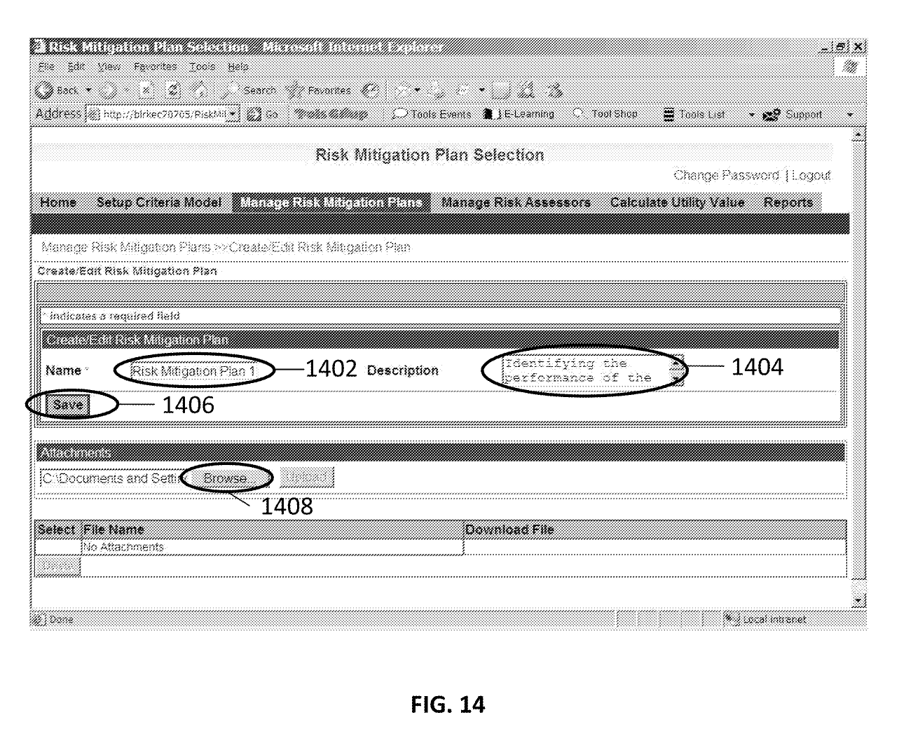

FIG. 14 is a screenshot of the user interface of the system for evaluating one or more risk mitigation plan alternatives, in accordance with an exemplary embodiment of the invention. The user interface enables experts to define risk mitigation plan alternatives. The name and description of a risk mitigation plan alternative is entered in textboxes 1402 and 1404, respectively. The entered details are saved by clicking on a save button 1406. Documents related to the description and execution of risk mitigation plan alternatives may be uploaded by clicking on a browse button 1408.

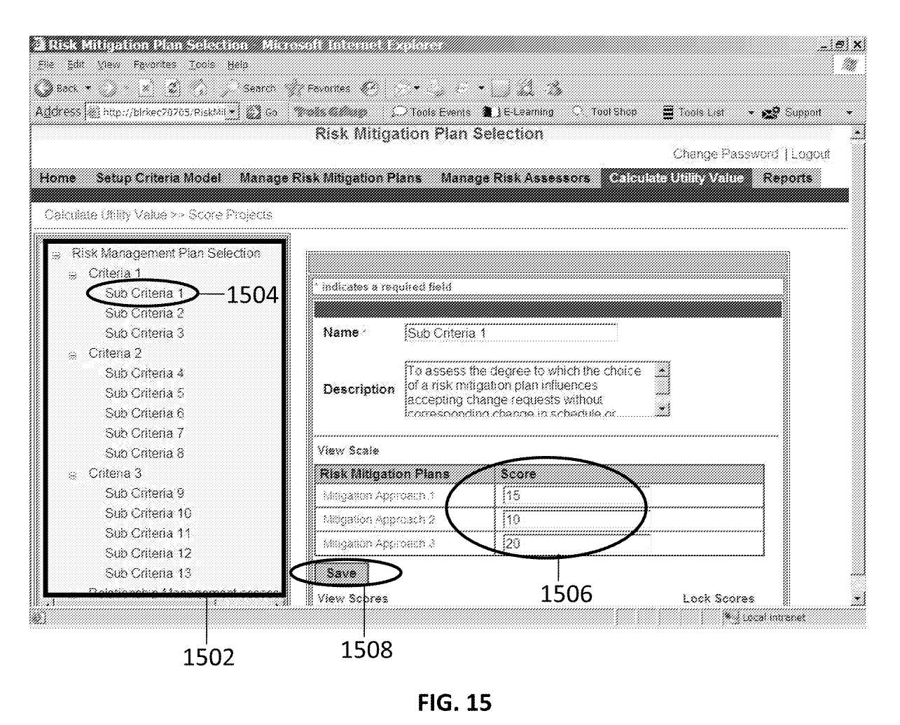

FIG. 15 is a screenshot of a user interface of a system for evaluating one or more risk mitigation plan alternatives, in accordance with another exemplary embodiment of the invention. FIG. 15 includes a criteria model tree 1502.

A risk assessor may assign scores to the risk mitigation plan alternatives with reference to the criteria in criteria model tree 1502. The assessor selects a sub-criterion 1504 to assign scores to the risk mitigation plan alternatives with reference to sub-criterion 1504. The scores are entered in one or more score textboxes 1506 and subsequently saved by clicking on a save button 1508.

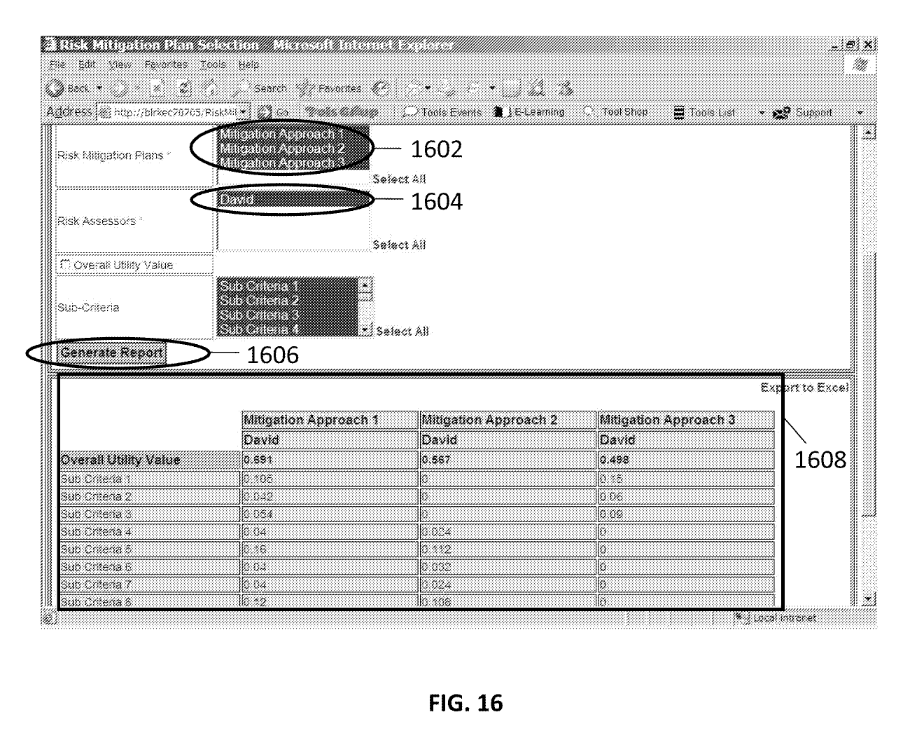

FIG. 16 is a screenshot of the user interface of the system for evaluating one or more risk mitigation plan alternatives, in accordance with another exemplary embodiment of the invention.

The expert selects the risk mitigation plan alternatives for which one or more reports need to be generated. In FIG. 16, an exemplary depiction of selecting mitigation approach 3 by using a box 1602 is given. Similarly, using a box 1604 illustrates the selection of a risk assessor for whom the report needs to be generated. Clicking on button 1606 generates a report 1608 for the selected risk mitigation plan alternatives and risk assessors.

Report 1608 contains the utility values of the selected risk mitigation plan alternatives with reference to the criteria. Report 1608 facilitates evaluation of the risk mitigation plan alternatives.

The invention provides a method, system and computer program product for a systematic evaluation of multiple risk mitigation plan alternatives, to select an optimal risk-mitigation plan from the available alternatives. The risk mitigation plan alternatives are assigned scores by experts with reference to multiple criteria. The multiple criteria are then assigned weights according to their impact on mitigating the risk. All the key stakeholders of the project are involved in the evaluation of the risk mitigation plan alternatives, to reduce the impact of risks on the project. Therefore, the views of all major stakeholders are taken into account while selecting an optimal risk-mitigation plan. Further, the uncertainty of scores assigned to the risk mitigation plan alternatives by the key stakeholders is also taken into account by assigning probabilities to the scores. In other words, a stakeholder might be uncertain of the score assigned to the risk mitigation plan alternative with respect to a predefined criterion. The uncertainty in the score is factored into the evaluation by assigning a probability to the score.

The method and system for evaluating risk mitigation plan alternatives to manage the risks related to a business process, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for evaluating a plurality of risk mitigation plan alternatives and selecting an optimal risk mitigation plan for managing risks related to a business process, the method comprising:
a. defining the plurality of risk mitigation plan alternatives related to the business process;
b. defining a criteria model comprising one or more criteria, wherein each of the plurality of risk mitigation plan alternatives are evaluated against the one or more criteria;
c. defining weights for each of the one or more criteria, wherein the weights are defined based on the relative impact of the one or more criteria in managing the risks;
d. assigning scores to the plurality of risk mitigation plan alternatives with reference to each of the one or more criteria, wherein the scores are assigned by one or more experts on the basis of a predefined scale;
e. evaluating the plurality of risk mitigation plan alternatives on the basis of the assigned scores, wherein the evaluation is done by the one or more experts; and
f. selecting the optimal risk mitigation plan for the business process on the basis of the evaluation.

2. The method of claim 1, wherein the criteria model comprises one or more sub-criteria for the one or more criteria.

3. The method of claim 1 further comprising assigning a probability to each of the plurality of risk mitigation plan alternatives with reference to each of the one or more criteria, wherein the probability is a measure of the uncertainty in the score assigned to the plurality of risk mitigation plan alternatives.

4. The method of claim 3 further comprising calculating a utility value for each of the plurality of risk mitigation plan alternatives with reference to each of the one or more criteria, the utility value being calculated on the basis of the weights and the assigned probabilities.

5. The method of claim 1 further comprising generating reports for each of the plurality of risk mitigation plan alternatives against the one or more criteria for evaluating the plurality of risk mitigation plan alternatives.

6. A system for evaluating a plurality of risk mitigation plan alternatives for managing risks related to a business process, the system comprising:
a. a criteria-definition module configured for defining a criteria model comprising one or more criteria;
b. a weight-definition module configured for enabling the one or more risk management experts to assign weights to the one or more criteria;
c. a risk-mitigation input module configured for enabling one or more risk management experts to define the plurality of risk mitigation plan alternatives;
d. a risk-assessor module configured for assigning one or more risk assessors for evaluating the plurality of risk mitigation plan alternatives against the one or more criteria;
e. a scoring module configured for enabling the one or more risk assessors to assign scores to the plurality of risk mitigation plan alternatives with reference to the one or more criteria; and
f. a calculation module configured for calculating a utility value for evaluating the plurality of risk mitigation alternatives, the utility value being calculated based on and the inputs received from the weight definition module and the scoring module.

7. The system of claim 6, wherein the scoring module comprises a probability-assignment module configured for enabling the one or more risk assessors to assign a probability to each of the plurality of risk mitigation plan alternatives with reference to each of the one or more criteria, wherein the probability is a measure of the uncertainty in the score assigned to the one or more criteria.

8. The system of claim 6 further comprising a report-generation module for generating reports based on the utility values for selecting an optimal risk mitigation plan.

9. A computer program product for use in a business establishment, the computer program product comprising a computer usable medium having a computer readable program code embodied therein for evaluating a plurality of risk mitigation plan alternatives for managing risks related to a business process, the computer readable program code performing:
a. enabling one or more experts to define the plurality of risk mitigation plan alternatives for the business process;
b. enabling the one or more experts to define a criteria model comprising one or more criteria for evaluating the plurality of risk mitigation plan alternatives;
c. enabling the one or more experts to assign weights to the one or more criteria, the weights being assigned based on the relative impact of the one or more criteria in reducing the risks related to the business process.
d. enabling the one or more experts to assign one or more risk assessors for evaluating the plurality of risk mitigation plan alternatives;
e. enabling the one or more risk assessors to assign scores to the plurality of risk mitigation plan alternatives with reference to the one or more criteria; and
f. evaluating the plurality of risk mitigation plan alternatives using the assigned scores.

10. The computer program product of claim 9, wherein the computer program code further performs enabling the one or more experts to define one or more sub-criteria for the one or more criteria.

11. The computer program product of claim 9, wherein the computer program code further performs enabling the one or more risk assessors to assign a probability to each of the plurality of risk mitigation plan alternatives with reference to the one or more criteria, wherein the probability is a measure of the uncertainty in the score assigned to the one or more criteria.

12. The computer program product of claim 11, wherein the computer program code further performs calculating a utility value for each of the plurality of risk mitigation plan alternatives with reference to each of the one or more criteria, the utility value being calculated on the basis of the weights and the probabilities.

13. The computer program product of claim 9, wherein the computer program code further performs generating reports based on the evaluation performed by the one or more risk assessors for selecting an optimal risk mitigation plan.
